(19) United States
(12) Patent Application Publication
(10) Pub. No.: US 2008/0296942 A1
(43) Pub. Date: Dec. 4, 2008

(54) Seat Comprising Wiring Fixed to a Support, Method for Assembling a Seat, and Use of a Flat Conductor for the Wiring of a Seat

(75) Inventor: Thomas Schweiker, Herrenberg Kayh (DE)

Correspondence Address: FOLEY & LARDNER LLP, 777 EAST WISCONSIN AVENUE, MILWAUKEE, WI, 53202-5306, US

(73) Assignee: Johnson Controls GmbH, Burscheid (DE)

(21) Appl. No.: 10/572,819

(22) PCT Filed: Sep. 23, 2004
(86) PCT No.: PCT/EP2004/010703

§ 371 Date: Aug. 25, 2008

(30) Foreign Application Priority Data
Sep. 23, 2003 (DE) 103 44 296.0

(51) Int. Cl. B60N 2/00; H01R 43/00

(52) U.S. Cl. 297/217.3; 29/592.1

(57) ABSTRACT

The invention relates to a seat, especially for a vehicle, said seat being provided with flat wiring that is easy to mount in and/or on a support.

The present invention relates to a seat, in particular for a vehicle, the wiring of which can be mounted in a flat and simple manner and is fitted in and/or to a support. The invention furthermore relates to a method for assembling a seat and to the use of a flat conductor for the wiring of a seat.

Vehicles are known in which, for the wiring, use is made of flat conductors in the roof lining or on door panels. The publication DE 199 30 014 discloses attaching strip conductors directly to an already existing component of the motor vehicle in order to facilitate the accommodating of wire harnesses in a roof lining or under carpets.

The seats of vehicles are equipped in ever more complex fashion, for example with motors for the automatic seat adjustment, seat heating systems or sensors. Since these seat components are generally to be connected electrically, the wiring of vehicle seats of this type is complicated. Up to now, use has been made of round conductors which are fixed to the supporting structure of the seat by means of fixing elements. For this purpose, the supporting structure is provided with holes, which is complicated in terms of the manufacturing and reduces the stability of the supporting structure.

The components of the vehicle seats have to withstand a sustained loading due to the weight of the occupants, due to the movements of the occupants and due to the dynamic loadings during the movement of the vehicle and must not have a negative influence on the seating comfort for the occupants.

Furthermore, the space in vehicles is to be used optimally and the weight and the costs minimized.

The publication DE 199 43 890 C1 describes a seat part of a motor vehicle seat, onto the spring supporting structure of which is clipped a plastic plate in which at least one socket for the connection of seat subassemblies required for seating functions and at least one socket for the connection to the vehicle electrical supply are integrated, the sockets being connected to one another by means of conductors cast into the plastic plate. The plastic plate has to be matched to the model series as a function of the components to be connected and of the shape of the seat. It requires separate and possibly complicated manufacturing and takes up a large amount of constructional space.

It is the object of the present invention to provide cost-effective wiring for seats, in particular for a vehicle, which wiring is simple to manufacture, can be mounted in a simple manner, is space-saving and hard-wearing, does not have a negative effect on the seating comfort and the weight of which is minimized.

The object is achieved by a seat, in particular for a vehicle, the seat having a supporting structure, a support and wiring, apart from seat heating systems, the wiring being fixed to the support.

By means of the fixing according to the invention of the wiring to the support of the seat, there is no need during assembly to fix the wiring to the supporting structure by means of fixing elements. The outlay on labor and the requirement for fixing elements become unnecessary, which has a favorable effect on the assembly costs, and the stability of the supporting structure is maintained because bores or holes do not need to be made in the supporting structure in order to fix the wiring.

The support is essentially of elastic and/or plastic design. It essentially matches the shape predetermined by the structure-forming components of the seat. In contrast to the structure-forming components of the seat, the support comprises at least all of the comfort-providing components of the seat. According to the invention, support in particular describes an upholstered support or an upholstery of the seat. A person skilled in the art understands that, apart from the comfort-providing support, the seat can have one or more further supports which extend preferably in a planar and therefore essentially two-dimensional manner and by means of which, for example and preferably, the wiring can be arranged in the seat. A person skilled in the art furthermore understands that the one or more further supports does/do not necessarily rest on the comfort-providing support.

The support is preferably at least partially multi-layered, with the wiring particularly preferably being fixed to one of the layers. The manufacturing of the support in a plurality of steps is thereby possible, with it being possible for the layer to which the wiring is fixed to be premanufactured before it is joined together with the further layer or further layers of the support.

A person skilled in the art understands that the wiring may also comprise the electrical supply (current supply line) of a seat heating system for the vehicle seat but does not contain the seat heating systems itself.

In a preferred embodiment, the layers are formed from different material. As a result, the support can be matched in a very flexible manner to the requirements of the seat, for example to heat resistance, ventilation, moisture repellency, moisture resistance or pressure distribution. It is composed in particular of foam materials, rubberized hair or the like, but may also have further layers, for example felt or fleece mats, or layers filled with wool padding or fleece. Recyclable materials are particularly preferably used.

The seat preferably has a plurality of supports, with the wiring being fixed to at least one of the supports. Depending on the position of the consumers to be connected, the arrangement of the wiring on one or more of the supports permits the use of short lines, with the result that the wiring is cost-effective. The arrangement of the wiring on each of the supports can be premanufactured before assembling the seat, so that the support can be mounted in a particularly simple manner during the assembly of the seat. For example, the support which has the wiring can be arranged on structure-forming components extending in an essentially planar manner or can even just be placed therein. The assembly of the seat can therefore be carried out very rapidly and is very cost-effective.

In a very particularly preferred embodiment, the wiring is fixed to a felt mat. As a result, the wiring is fixed on an essentially flat surface, which can be carried out in a simple and rapid manner, in particular with the wiring prefolded. Prefolded wiring takes up little space in terms of storage. Felt mats are durable and cost-effective. A person skilled in the art understands that, instead of felt mats, use can also be made of mats of different materials that are of essentially planar design, i.e. essentially two-dimensional design.

In a particularly preferred embodiment, the felt mat forms one of the plurality of supports. The support is particularly preferably arranged on a structure-forming seat component which extends in an essentially planar manner, for example the cushion shell. In this embodiment, the comfort-providing support which forms the upholstery and, if appropriate, at least partially contains further functions, for example a seat airbag, is therefore not changed by the arrangement of the wiring. The arrangement of a support according to the invention, for example a felt mat, on the surface of the cushion shell, which lies opposite the comfort-providing support, has the advantage that the seating comfort for the user cannot be affected at all by the wiring, and the material of the wiring can therefore be of less comfortable design, for example of less flexible design, than the arrangement of the wiring in or on the comfort-providing support. Conventional wiring, in particular flat conductors, can therefore be used.

An embodiment is likewise advantageous, in which, apart from the comfort-providing support, the seat has a further support which has the wiring and is formed, for example, of a foam material instead of a felt mat, with the supporting structure of the seat being provided essentially in the form of a frame, for example in the form of a lattice.

The wiring preferably comprises flat conductors, with the wiring being in particular FFC (foil-insulated copper tracks, Flexible Flat Cable), FFCe (Flexible Flat Cable extruded) and/or FPC (printed foil circuits, Flexible Printed Circuit). The difference between FFC material and FFCe material is that, in contrast to FFC material, FFCe material is extruded rather than laminated.

A person skilled in the art recognizes that other flat conductors which have a thickness which is as small as possible, advantageously in the order of magnitude of 1 mm or below, are also suitable.

Flat conductors may advantageously have a multiplicity of conductors. As a result, a plurality of consumers, and, if appropriate, consumers to be connected in a complicated manner, can be connected to the wiring. A person skilled in the art recognizes that all electric conductors are suitable.

The use of the flat conductors makes it possible, if appropriate, to reduce the weight of the wiring in comparison to the wiring using round conductors, for example, if appropriate, because the flat conductors can be guided more directly between the consumers/connecting points to be connected than the round conductors which essentially have to be guided along the supporting structure of the seat.

In addition, FFC and FPC wiring can be recycled comparatively easily.

Owing to its small thickness, the wiring is virtually two-dimensional and is therefore suitable in a particular manner for laying two-dimensionally. The wiring can therefore be fitted in a very simple manner on surfaces which can be or are arranged essentially flat.

When flat conductors are used, less constructional space is required owing to their minimal thickness.

In particular in the region of the seat surface and in the region of the backrest surface, i.e. the respective main surfaces which are in contact with an occupant of the vehicle, the connecting surface between the structure-forming components of the seat and the support is of essentially planar design, i.e. of essentially two-dimensional design. In this region, the use according to the invention of seat wiring that is provided with flat conductors is particularly preferred.

In a preferred embodiment of the invention, the wiring can therefore be provided in the support, i.e. can be integrated or at least partially integrated in the layer structure of the support. This saves on fixing elements, in particular on the supporting structure, so that holes do not have to be provided for the fixing elements in the supporting structure, the stability of the supporting structure is not reduced and the manufacturing is therefore less complicated and more cost-effective.

The support preferably has a visible side and a rear side, and the wiring is provided on the rear side. As a result, the wiring is not visible, and the seat's appearance is retained. Furthermore, the wiring is as a result arranged as far away as possible from the occupant of the vehicle, so that, on the one hand, losses of comfort are reduced and, on the other hand, forces exerted by the occupant and/or other effects, such as, for example, moisture, temperature or the like, are largely kept away from the wiring. In this connection, according to the invention, the wiring is provided in particular on the rear side of the support. The front side or the visible side of the support preferably has a decorative layer.

Owing to the comparatively small thickness of the wiring and the elasticity and/or plasticity of the support, the seating comfort is not negatively affected by fitting the wiring in the support and/or to the support, and, given a comparable seat volume/weight, said seat may be more comfortable because more space/weight is possible for the upholstery.

In addition, the support and/or the layers of the support can have depressions in which the wiring is placed, or the wiring can be embedded in layers of preferably identical materials.

Particularly preferably, the felt mat forms the rear side of the support. The wiring is therefore protected by the felt mat, in particular when laid onto a spring mat and/or further structure-forming components of the seat.

The fixing of the wiring preferably takes place by adhesive bonding and/or by means of touch-and-close strips and/or by means of further fixing means. A person skilled in the art understands that all further fixing means which ensures a secure connection without the wiring becoming loose, even when the wiring is subjected to continuous stress, for example due to the movements of the occupant, heat or moisture, are suitable.

For example, the support can be composed of a looped braided fabric on the side on which the wiring is fixed, i.e. on the rear side, or a looped braided fabric can easily be sewn and/or adhesively bonded onto the support, so that the wiring can easily be fixed, for example with touch-and-close fasteners, on the looped braided fabric or by means of the looped braided fabric. Furthermore, the wiring can also be adhesively bonded directly onto the support. The adhesive bonding or fixing by means of touch-and-close strips of the wiring to a warp-knitted fabric or braided fabric or, in particular, to a felt mat can easily and rapidly be carried out, so that this fixing of the wiring is very cost-effective.

In a preferred embodiment, a plurality of layers of the wiring are arranged one above another. In one possible embodiment, for each layer of the wiring a layer of the support is provided to which the wiring is fixed. This also makes it possible to spatially achieve a modular separation of the functions for which the wiring is used. In a further embodiment, a plurality of layers of the wiring are fixed to a layer of the support, so that less space is required.

By arranging a plurality of layers of the wiring one above another, a large number of variants of the overall wiring system can be achieved with identical or similar layers of the wiring. The piece numbers for producing the layers of the wiring are therefore higher, and the wiring can be manufactured more cost-effectively. The stock keeping is cost-effective because of the small number of parts.

Also when a plurality of layers of the wiring are arranged one above another, the comparatively small thickness means that the constructional space required in the seat is small, and the seating comfort is not negatively affected.

In a preferred embodiment of the seat, circuit components are parts of the wiring.

Circuit components within the context of the invention are plugs, sensors, passive components, active components, integrated circuits and/or complex circuits which have been/are in particular integrated in the wiring (during its production). A person skilled in the art recognizes that circuit components may also comprise electric components. In particular when the wiring is designed as FPC material, some of the circuit components may be placed in the wiring merely by changing the conductor materials or cross sections—for example, if a resistance is required—or by means of a special arrangement of the conductors—for example, if a coil is required. As a result, the number of parts in the manufacturing of the seats is reduced considerably, the assembly is considerably simplified, and the costs are significantly reduced. Owing to the absence of intermediate contacts, the error frequency, for example due to loose connections, in particular due to continuous sudden loading during operation of the vehicle, is lower. The saving of intermediate contacts is cost-effective, since not only the components but also the outlay on adaptation and assembly are also omitted.

The wiring or parts of the wiring may be used as bus lines for transmitting data and/or as an antenna.

The wiring is preferably connected to connecting components by manufacturing in advance, soldering, plugging in and/or clamping.

Connecting components which are arranged in the region of the support are, for example, fan motors or sensor mats. These are preferably already connected to the wiring during the production thereof (manufacturing in advance). Supporting structure components are those which are placed on or in the immediate vicinity of the supporting structure, for example motors and/or control devices. According to the invention, supporting structure components are connected to the wiring and/or to connecting components in particular by means of soldering, plugging in and/or clamping.

A person skilled in the art recognizes that any form of connection for connecting electric conductors is suitable that provides adequate connecting security and requires little space.

Connecting components are preferably connected during and/or directly after the fixing of the wiring to a layer of the support. A subassembly which only comprises one layer of the support and the wiring is clearer than a subassembly which comprises a plurality of layers of the support and the wiring, or in which parts of the support have already been fitted onto the seat. Owing to the better clarity, the connecting of connecting components during and/or directly after the fixing of the wiring to a layer of the support can be carried out more simply and rapidly, with the frequency of erroneous connections being reduced at the same time. In addition, fitters can at least partially undertake the connecting in this manufacturing step in an upright position or sitting, since the volume of an individual layer of the support is small and less bulky in comparison to a multilayered subassembly or the seat. In addition, smaller layers can be placed onto a table. The connection also does not have to be carried out in areas to which access is difficult, or even in areas in which there is a risk of injury for the fitters, in particular to their hands. As a result, the handling is overall simplified for the fitters.

The wiring is preferably connected to supporting structure components by means of interlacing connections and/or short branch connections. This is to be understood in particular as meaning that the wiring is, if appropriate, not connected fixedly to the support in all of its subregions but in particular is at least partially flexible at its connection ends, so that such a subregion of the wiring can be brought towards the supporting structure components for connection thereto. In this case, connection ends of this type are moved in particular out of the plane of the wiring, so that the wiring overall assumes a three-dimensional structure. If the wiring is fitted to the support by means of touch-and-close fastenings, an “interlacing connection” or “short branch connection” is formed, for example, by one of the ends of the wiring as far as the last (preceding) touch-and-close point.

The supporting structure comprises all of the structure-providing components of the seat. Supporting structure components, such as, for example, motors or control devices, may be situated in its vicinity. According to the invention, the interlacing connections and/or short branch connections are parts of the wiring and are connected fixedly thereto.

As a result, the dependency of the wiring on the supporting structure is minimal, and the wiring and the supporting structure can very largely be developed independently of one another. The construction of the wiring and its assembly is therefore simple.

The wiring is preferably essentially as flexible as or more flexible than the support, in particular in its installed state. The effect brought about by this is that the wiring is not subjected to greater ageing due to the movements caused at or on the seat than the support. As a result, furthermore, the laying of the wiring is first of all simple, and it is furthermore possible to fix the wiring to the support.

The wiring is namely exposed to considerable forces, for example to a surface loading by the weight of the occupants or to spot-type loadings when angular objects are deposited on the seat. The wiring adapts itself because of its flexibility to the seat shape and the loadings, and is hard-wearing.

Vehicle seats are frequently moved, for example on adjusting the backrest of the seat, the seat height or the distance from the cockpit. As a result, distances of the wiring from components of the seat, for example motors or control devices, may change time and again. The flexibility of the wiring prevents such movements having a damaging effect. During construction, the adaptation of the wiring to different geometries of different seats is easier because of its flexibility.

The object is furthermore solved by a method for assembling a seat, in particular for a vehicle, the seat having a supporting structure, a support and wiring, apart from seat heating systems, the method comprising the following steps:
a) fixing the wiring to a layer of the support,
b) fitting layers of the support onto the seat,
c) joining together the support,
   with step c.) taking place either before step b) or after step b). As a result, the fixing of the wiring takes place independently of its fitting onto the seat.

The wiring of the seat is therefore very largely independent of its supporting structure.

The outlay for the fixing of the wiring to the supporting structure of the vehicle by means of fixing elements is omitted. The stability of the supporting structure is retained, the fixing elements are not required, and the outlay on labor is significantly lower.

In addition, the connection of the connecting components and/or of the supporting structure components to the wiring is simple.

The object is furthermore achieved by the use of a flat conductor for the wiring, apart from seat heating systems, of a seat having a support, in particular for a vehicle, the wiring being fixed in the support and/or to the support.

The constructional space required for the wiring of the seat is small because of the use of flat conductors. The weight of the wiring is, if appropriate, lower in comparison to the wiring by means of round conductors. The wiring can be fastened rapidly and simply in and/or to the support, and the installation of the seat is therefore simple and cost-effective. By manufacturing the wiring and, if appropriate, connecting components in advance as a subassembly, the outlay on storage, manufacturing and assembly is reduced and is cost-effective.

The described wiring for a seat, in particular for a vehicle, is hard-wearing, can be mounted in a simple manner, is cost-effective and space-saving. Its weight is minimized, and it does not have a negative effect on the seating comfort. In addition, when the wiring according to the invention is used, the constructional space required is small.

The invention is explained below using exemplary embodiments with reference to the drawings, in which

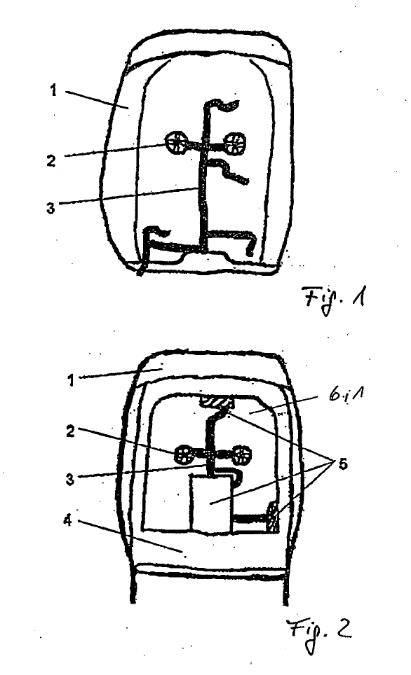

FIG. 1 shows, diagrammatically, a possible arrangement of the wiring of the backrest of a seat for a vehicle.

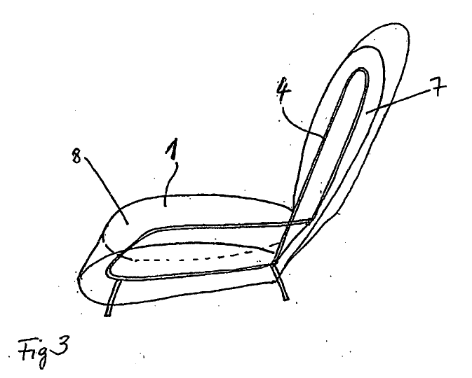

FIG. 2 shows, diagrammatically, a possible arrangement of the wiring of the backrest of a seat for a vehicle after it has been upholstered on the supporting structure.

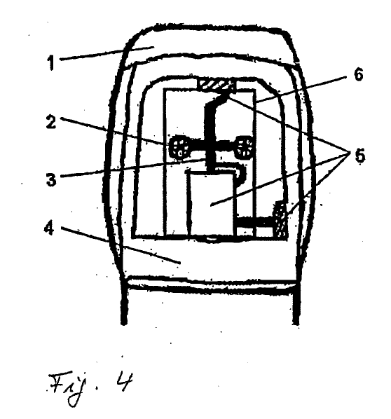

FIG. 3 shows, diagrammatically, a possible embodiment of a seat for a vehicle.

FIG. 4 shows, diagrammatically, a further possible arrangement of the wiring of the backrest of a seat for a vehicle after it has been upholstered on the supporting structure.

FIG. 1 diagrammatically illustrates a possible arrangement of the wiring 3 of the backrest of a seat for a vehicle. The wiring 3 is fixed in and/or to the support 1 and, according to the invention, in particular comprises flat conductors. It is connected to connecting components 2, such as, for example, seat heating elements or fan elements, which are installed in the seat, to be precise essentially in the region of the support 1. In this case, a seat heating element can also be installed in particular in a decorative layer—for example material or leather. The support 1 comprises both the support of a backrest part 7 (not separately denoted by means of a reference number) and also the support 1 of a seat (not separately denoted by means of a reference number). Both the backrest part 7 and the seat part 8 of the seat that are illustrated in FIG. 3 have a supporting structure 4—which is provided in particular in metallic form—and which is referred to overall as the supporting structure 4 of the seat. According to the invention, the supporting structure 4 may also, of course, be made from plastic or another suitable material. Furthermore, both the backrest part 7 and the seat part 8 with their respective portions of the supporting structure 4 have essentially largely flat surfaces which are in contact as main surfaces of use with an occupant or a user of the seat, but with the support 1 being situated between these surfaces of the supporting structure 4 and the user. The wiring 3 is then integrated between the supporting structure 4 and the support 1 or in the support 1 at least in the vicinity of the connecting surface between the supporting structure 4 and the (rear side of the) support 1. According to the invention, this connecting surface is provided in largely flat form, at least in comparison to the flexibility of the support 1 or the wiring 3.

FIG. 2 diagrammatically illustrates a possible arrangement of the wiring 3 of the backrest of a seat for a vehicle. Connecting components 2 which are arranged on or in the region of the support 1 are illustrated. Parts of the supporting structure 4 on which or in the immediate vicinity of which supporting structure components 5, for example motors or control devices, are situated are also illustrated. During assembly, the supporting structure components 5 are connected to the wiring 3 by means of interlacing connections and/or short branch connections (not denoted specifically by a reference number).

The support 1 which has the wiring 3 is manufactured from a material extending essentially in planar form, for example a fleece or felt mat 6, and, in a possible embodiment, forms a layer of the support 1—if the supporting structure 4 illustrated is in the form of a frame—or, in a likewise possible embodiment, a further support 1 of the seat—if the supporting structure 4 illustrated extends at least partially in planar form over the backrest 7.

The invention can be used in seats of many types of vehicle, for example cars, ships or aircraft.

FIG. 3 illustrates a possible embodiment of a seat for a vehicle. The seat comprises a support 1 and a supporting structure 4. The supporting structure 4 comprises all of the structure-providing components of the seat, and the support 1 comprises at least all of the comfort-providing components of the seat. The structure-forming components 4 are provided in the form of a frame. The seat has an essentially vertically arranged backrest 7 and an essentially horizontally arranged seat part 8.

FIG. 4 shows, diagrammatically, a further possible arrangement of the wiring 3 of the backrest 7 of a seat for a vehicle after it has been upholstered on the supporting structure 4. The support 1 comprises a felt mat 6 to which the wiring 3 is fixed. The connecting components 2 are arranged on the felt mat. The connection of the connecting components 2 to the wiring 3 takes place during and/or immediately after fixing the wiring 3 to the felt mat 6 and independently of the joining together of the support 1. The supporting structure components 5 are connected to the wiring 3 by means of interlacing connections and/or short branch connections.

In a particularly preferred embodiment, the wiring of a seat in the seat part 8 takes place by means of a support 1 in the form of a felt or fleece mat 6 which is arranged below a cushion shell which is a supporting structure 4 of the seat that extends essentially in planar form. In this embodiment, the support 1 with the wiring 3 and essentially the comfort-providing components with at least parts of the supporting structure 4 can be premanufactured separately from one another, so that the assembling of the seat by arranging the premanufactured support 1 on the supporting structure 4 can take place very rapidly and therefore cost-effectively.

### List of Reference Numbers:

1 Support
2 Connecting components
3 Wiring
4 Supporting structure
5 Supporting structure components
6 Felt mat
7 Backrest
8 Seat part

1. A seat, in particular for a vehicle, the seat having a supporting structure (4), a support (1) and wiring (3), apart from seat heating systems, characterized in that the wiring (3) is fixed to the support (1).

2. The seat of claim 1, characterized in that the support (1) is at least partially multi-layered, with the wiring (3) preferably being fixed to one of the layers.

3. The seat of claim 1, characterized in that the layers are formed from different material.

4. The seat of claim 1, characterized in that it has a plurality of supports (1), and in that the wiring (3) is fixed to at least one of the supports (1).

5. The seat of claim 1, characterized in that the wiring (3) is fixed to a felt mat (6).

6. The seat of claim 5, characterized in that the felt mat (6) forms one of the plurality of supports (1).

7. The seat of claim 1, characterized in that the wiring (3) comprises flat conductors.

8. The seat of claim 1, characterized in that the wiring (3) is fitted in the support (1).

9. The seat of claim 1, characterized in that the support (1) has a visible side and a rear side, and in that the wiring (3) is provided on the rear side of the support (1).

10. The seat of claim 5, characterized in that the felt mat (6) forms the rear side of the support (1).

11. The seat of claim 1, characterized in that the fixing of the wiring (3) takes place by adhesive bonding and/or by means of touch-and-close strips and/or by means of further fixing means.

12. The seat of claim 1, characterized in that a plurality of layers of the wiring (3) are arranged one above another.

13. The seat of claim 1, characterized in that circuit components are parts of the wiring (3).

14. The seat of claim 1, characterized in that the wiring (3) is connected to one of the connecting components (2) or a supporting structure component (5) by manufacturing in advance, soldering, plugging in and/or clamping.

15. The seat of claim 14, characterized in that the wiring (3) is connected to the supporting structure component (5), which is placed on or in the immediate vicinity of the supporting structure (4), by means of interlacing connections and/or short branch connections.

16. The seat of claim 1, characterized in that the wiring (3) is essentially as flexible as the support (1) or is more flexible than the support (1).

17. A method for assembling a seat, in particular for a vehicle, the seat having a supporting structure (4), a support (1) and wiring (3), apart from seat heating systems, characterized in that the method comprises the steps of:
a) fixing the wiring (3) to a layer of the support (1);
b) fitting layers of the support (1) onto the seat;
c) joining together the layers of the support (1); and
wherein step c) takes place either before or after step b).

18. A vehicle seat having a flat conductor wiring therein, the flat conductor wiring being apart from any seat heating system, the vehicle seat comprising a seat having a support, the flat conductor wiring being fixed to the support.

19. The vehicle seat of claim 18 wherein the flat conductor wiring is fixed in the support.
